(19) United States
(12) Patent Application Publication
(10) Pub. No.: US 2014/0078533 A1
(43) Pub. Date: Mar. 20, 2014

(54) PRINTING SYSTEM, SERVER, INFORMATION DEVICE, AND COMPUTER-READABLE STORAGE MEDIUM FOR COMPUTER PROGRAM

(71) Applicant: KONICA MINOLTA, INC., Chiyoda-ku (JP)

(72) Inventor: Toshinobu YAMAGUCHI, Takarazuka-shi (JP)

(73) Assignee: KONICA MINOLTA, INC., Chiyoda-ku (JP)

(21) Appl. No.: 14/014,887

(22) Filed: Aug. 30, 2013

(30) Foreign Application Priority Data
Sep. 18, 2012 (JP) 2012-204494

(51) Int. Cl. G06F 3/12

(52) U.S. Cl. CPC G06F 3/1205
USPC 358/1.13

(57) ABSTRACT

A printing system including a client terminal and a server is provided. The server includes a storage portion configured to store therein rule information, the rule information indicating print rules associated with intended uses of a printed matter, and a control unit configured to inform the client terminal of the intended uses in response to a print command from the client terminal. The server modifies print settings designated in an original job that is a print job sent from the client terminal to the server in accordance with the print rules associated with one intended use selected by a user of the client terminal, and gives, instead of the original job, a rule-based job to the printing device, the rule-based job being a print job in which post-modification print settings are designated.

This application is based on Japanese patent application No. 2012-204494 filed on Sep. 18, 2012, the contents of which are hereby incorporated by reference.

### BACKGROUND OF THE INVENTION

1. Field of the Invention

The present invention relates to a technology for using a server to cause a printing device to execute a print job.

2. Description of the Related Art

Rule-based printing is known as a form of network printing involving a server. In the rule-based printing, a server forcedly changes the details of print settings indicated in a print job sent from an information device (client terminal) that is a print request source to the server in such a manner that the details of print settings conform with predefined print rules. For example, under a rule of limiting print color to monochrome, the server forcedly changes settings of color printing to settings of monochrome printing. Then, a printing device is given, instead of the original print job, a print job in which print settings have been changed accordingly.

According to such rule-based printing, printing can be performed at a reduced cost. A printing system has been proposed in which printing conditions are changed in such a manner that full-color printing is changed to monochrome printing, single-sided printing is changed to double-sided printing, the number of printed pages on one surface of paper is changed from 1 to 2, and paper to be used for printing is changed from ordinary paper to recycled paper (see Japanese Laid-open Patent Publication No. 2010-256958).

In conventional rule-based printing, information constituting print rule conditions is limited to information extractable from a print job. Here, the information extractable from a print job is, for example, an identification code of a client terminal (or an identification code of a user thereof), information indicated in meta data accompanied with a print target document (e.g., document file name), information of a document itself such as letter or attributes discriminable through automatic analysis. Such extractable information is automatically determined at a stage when a print target document is designated in the client terminal. For this reason, the conventional rule-based printing does not allow a user to obtain printed matters produced based on different print settings on the identical document.

For printing of the identical document, print settings should be changed in some cases depending on the intended use of a printed matter. An example of such cases is that printed matters for clients have to be produced in color while printed matters for internal use are printed in monochrome.

### SUMMARY

The present disclosure has been achieved in light of such an issue, and therefore, an object of an embodiment of the present invention is to provide a rule-based printing system capable of producing printed matters depending on the intended use thereof.

According to an embodiment of the present invention, a printing system includes a client terminal configured to generate a print job; and a server configured to issue a print command in accordance with the print job to a printing device. The server includes a storage portion configured to store therein rule information, the rule information indicating print rules associated with intended uses of a printed matter, and a control unit configured to inform the client terminal of the intended uses in response to a print command. The client terminal includes a receiving portion configured to receive a print command in accordance with print setting operation made by a user, an intended use selection control unit configured to display an operating screen in which selection operation for selecting one from among the intended uses informed by the server in response to the print command is performed, and a communication portion configured to inform the server of the intended use selected in the operating screen. The server modifies print settings designated in an original job that is a print job sent from the client terminal to the server in accordance with the print rules associated with the intended use selected, and gives, instead of the original job, a rule-based job to the printing device, the rule-based job being a print job in which post-modification print settings are designated.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of a network printing environment according to an embodiment of the present invention.

FIG. 2 is a diagram showing a first example of rule information applied to printing.

FIG. 3 is a block diagram showing a first example of the functional configuration of a printing system.

FIG. 4 is a diagram showing a first example of an operating screen on which the intended use of a printed matter is selected.

FIG. 5 is a sequence diagram showing a first example of operation performed in a printing system.

FIG. 6 is a sequence diagram showing a second example of operation performed in a printing system.

FIG. 7 is a diagram showing a second example of rule information.

FIG. 8 is a block diagram showing a second example of the functional configuration of a printing system.

FIG. 9 is a diagram showing a second example of an operating screen on which the intended use of a printed matter is selected.

FIG. 10 is a sequence diagram showing a third example of operation performed in a printing system.

FIG. 11 is a diagram showing a third example of rule information.

FIG. 12 is a diagram showing a typical example of the hardware configuration of a client terminal.

### DESCRIPTION OF THE PREFERRED EMBODIMENTS

### First Embodiment

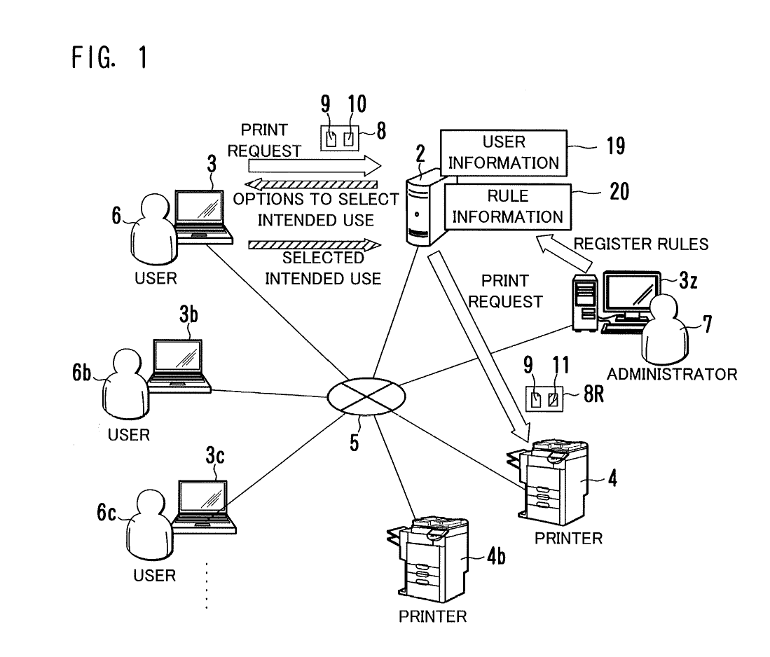

FIG. 1 shows an example of a network printing environment. In the illustrated example, a Local Area Network (LAN) 5 is constructed in a corporate office. Through the LAN 5, a server 2, client terminals 3, 3b, and 3c, printers 4 and 4b, and a personal computer 3z for management are connected to one another for mutual communication. Examples of the server 2 are a machine designed specifically for server and a personal computer. Alternatively, the server 2 may be incorporated into the printer 4 or the printer 4b. The client terminals 3, 3b, and 3c may be any devices as long as the devices are capable of running software for making a print request. Examples of the client terminals 3, 3b, and 3c are information devices such as a personal computer, a tablet personal computer, and a smartphone. The printers 4 and 4b are not limited to printing dedicated devices but may be Multi-functional Peripherals (MFPs) having capabilities of copying, scanning, and so on.

Users 6, 6b, and 6c of the client terminals 3, 3b, and 3c obtain printed matters under the network printing environment. The users 6, 6b, and 6c operate the client terminals 3, 3b, and 3c respectively to instruct the same to produce printed matters. In response to the instructions, the client terminals 3, 3b, and 3c request the server 2 to produce printed matters. The server 2 then causes any one of the printers 4 and 4b to perform printing. FIG. 1 shows a case where the print request made by the client terminal 3 is conveyed to the printer 4.

Predetermined print rules are applied to the network printing through the server 2 as discussed above. In short, so-called rule-based printing is performed in the network printing through the server 2. The server 2 has user information 19 that is management information on a user-by-user basis and rule information 20 indicating print rules registered by an administrator 7. The server 2 appropriately modifies, in accordance with the print rules indicated in the rule information 20, print settings information 10 contained in an original job 8 that is a print job received from the client terminal 3, 3b, or 3c. The server 2 then conveys a rule-based job 8R that is a print job containing post-modification print settings information 11, for example, to the printer 4. Print target data (document data) 9 contained in the original job 8 is included as-is in the rule-based job 8R.

According to the print rules, settings for printing of the identical print target data 9 should be modified depending on the “intended use” of a printed matter of the print target data 9. Stated differently, the print rules have an item of “intended use” in conditions under which print settings of the print rules are determined. Accordingly, even when the same user (for example, user 6) gives commands to perform printing based on the identical print target data 9 at different times, the resultant printed matters are different depending on the purpose thereof. For example, the printed matter is produced in color in some cases and is produced in monochrome in other cases.

The use of a printed matter produced based on the print target data 9 is not known even if the print target data 9 and the print settings information 10 are analyzed. The user 6, 6b, or 6c who provides print instructions specifies the use of a printed matter. Note, however, that the uses designatable by the users 6, 6b, and 6c are limited to uses that are set as options in the rule information 20.

In view of this, as shown in FIG. 1, the server 2 informs the client terminal 3, which is the print request source, of options (a list of uses) from which an intended use defined in the rule information 20 is selected. The client terminal 3 displays the options thus notified, and informs the server 2 of an option (intended use) selected by the user 6. The server 2 then changes the print settings information 10 to print settings information 11 in accordance with the intended use selected by the user and information originally contained in the original job 8 (identification code of the user 6 or the client terminal 3, the print target data 9 itself, or attributes indicated in meta data thereof).

Descriptions are provided below of an example of the print rules under which print settings are determined depending on the intended use of a printed matter, and an example of the configuration of the printing system related to application of the print rules.

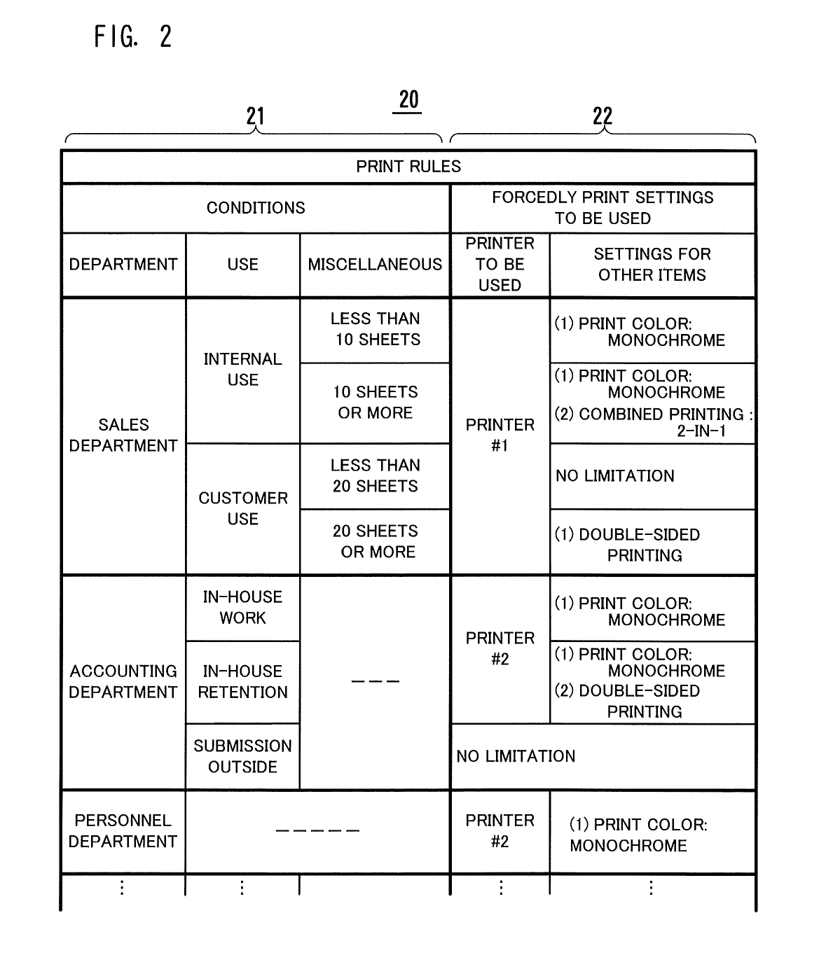

FIG. 2 shows a first example of the rule information 20. The rule information 20 has a section 21 showing “conditions” based on which applications of rules are classified into groups, and a section 22 showing “forcedly print settings to be used” corresponding to each of the groups classified. As shown in the rule information 20, the conditions have three items of “department”, “use”, and “miscellaneous”. The forcedly print settings to be used have two items of “printer to be used” and “other item settings”.

For “department” of the conditions, departments such as a sales department, an accounting department, and a personnel department are provided. Identification information on the client terminals 3, 3b, and 3c are registered in advance. Accordingly, it is possible to identify departments to which the users 6, 6b, and 6c belong based on communication data at the time of connection between the client terminals 3 and the server 2. For the case where user authentication is performed in order to allow a user to operate the client terminal 3, 3b, or 3c, a department to which the allowed user belongs is identifiable from an identification code of the allowed user.

The “use” of the conditions is an item corresponding to the intended use of a printed matter. In the illustrated example, two uses of “internal use” and “customer use” are provided as options for the sales department. Three uses of “in-house work”, “in-house retention”, and “submission outside” are provided as options for the accounting department. No options are provided to select an intended use of a printed matter for the personnel department.

Referring to “miscellaneous” of the conditions for the sales department, grouping is made based on the number of pages to be used for one-time printing. To be specific, when the use is “internal use”, two groups of “less than 10 sheets” and “10 sheets or more” are made. When the use is “customer use”, two groups of “less than 20 sheets” and “20 sheets or more” are made. No groups are provided to select “miscellaneous” in the accounting department.

Turning now to the section 22 (forcedly print settings to be used) of the rule information 20, the details of change to be made to print settings are associated with each of the groups made in accordance with “conditions” of the section 21. For example, the print rules for the sales department are as follows:

1) A printer to be used is always a printer numbered “1” (#1), e.g., printer 4, irrespective of grouping in “use” and “miscellaneous” of the conditions;

2) As long as “internal use” is shown in “use”, print color is limited to monochrome irrespective of the grouping based on the number of pages indicated in “miscellaneous”;

3) When “internal use” is shown in “use”, and when the number of pages to be printed is “10 sheets or more”, the print color is limited to monochrome, and further, 2-in-1 printing is performed to print 2 pages of a document onto one surface of paper. When 2-in-1 printing is set in the original job 8, settings for combined printing are reflected as-is in a rule-based job 8R;

4) When “customer use” is shown in “use”, and when the number of pages to be printed is “less than 20 sheets”, no print settings are forcedly changed except the limitation to a printer to be used. Stated differently, print settings for the original job 8, except for designation of a printer to be used, are reflected in the rule-based job 8R; and

5) When “customer use” is shown in “use”, and when the number of pages to be printed is “20 sheets or more”, printing is limited to double-sided printing. To be specific, setting is forcedly changed from single-sided printing to double-sided printing. When double-sided printing is set in the original job 8, the setting for double-sided printing is reflected as-is in the rule-based job 8R.

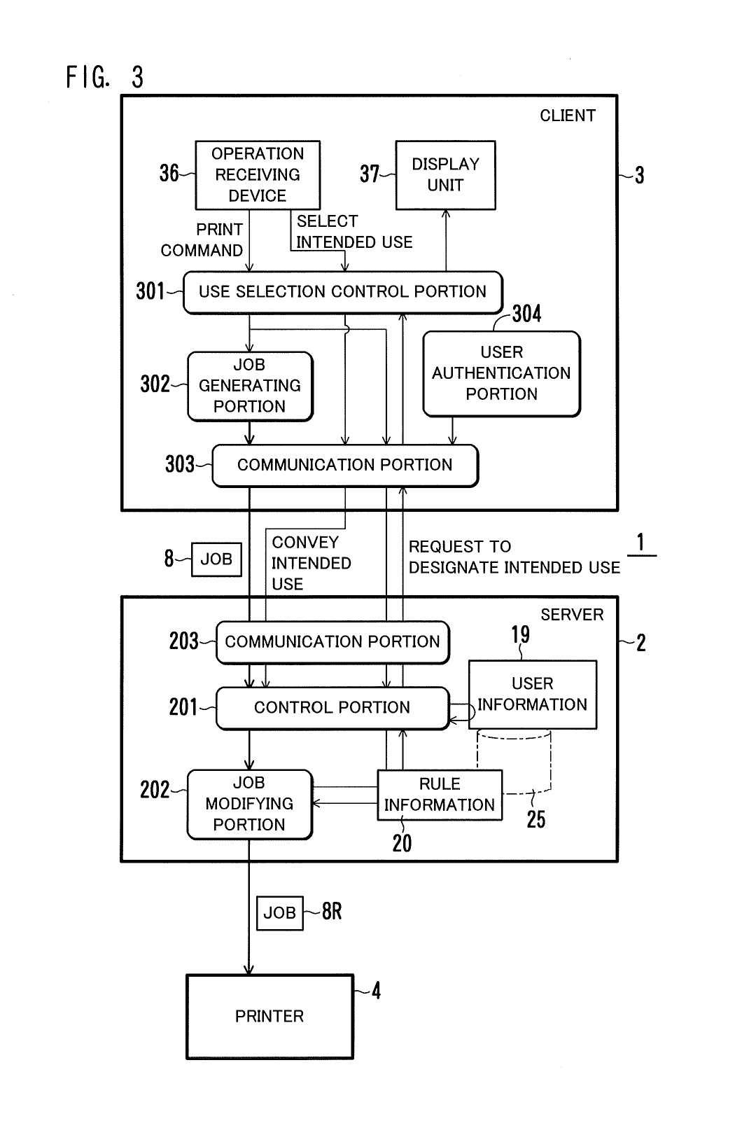

FIG. 3 shows the functional configuration of a printing system 1 according to the first embodiment of the present invention. The printing system 1 is configured of at least one client terminal 3, the server 2, at least one printer 4, and so on. As described above, the server 2 may be incorporated into the printer 4.

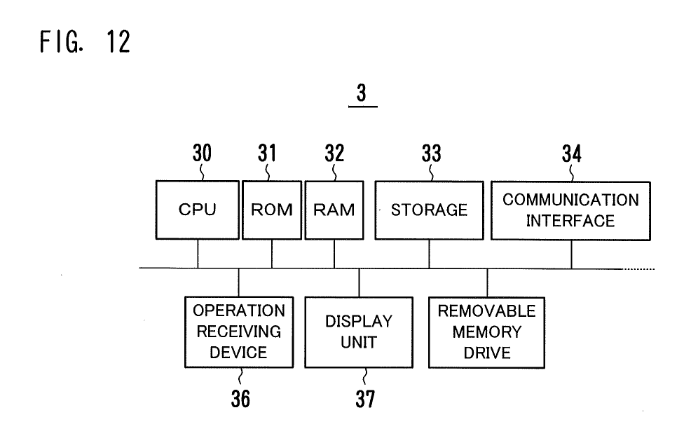

The client terminal 3 is configured of a use selection control portion 301, a job generating portion 302, a communication portion 303, a user authentication portion 304, and so on. The hardware configuration of the client terminal 3 is shown in FIG. 12. The client terminal 3 has a Central Processing Unit (CPU) 30 mounted as a computer. The CPU 30 loads a predetermined program from a Read-Only Memory (ROM) 31 or a storage 33 into a Random Access Memory (RAM) 32, and executes the predetermined program. Thereby, the functional elements constituting the client terminal 3 are implemented.

The use selection control portion 301 performs processing for selecting the intended use of a printed matter by a user. When the user performs operation on the operation receiving device 36, a non-illustrated receiving portion accepts the user operation. When the receiving portion receives a print command from the user, the use selection control portion 301 informs the job generating portion 302 of the print command. When a use designation request is received from the server 2 through the communication portion 303, the use selection control portion 301 displays, on a display unit 37, options to select an intended use of a printed matter in response to the use designation request. When the user selects one from among the options, the use selection control portion 301 conveys the intended use selected by the user to the communication portion 303.

The job generating portion 302 generates an original job 8. The original job 8 includes an instruction part called a job ticket containing the print settings information 10, and print target data 9 for specifying an image to be printed. The job generating portion 302 describes the job ticket in a Printer Job Language (PJL), and describes the print target data 9 in a Page Description Language (PDL). The job generating portion 302 then delivers the generated original job 8 to the communication portion 303.

The communication portion 303 serves to perform communication with the server 2 through a communication interface 34 that is not shown in FIG. 3. The communication portion 303 delivers, to the use selection control portion 301, the use designation request received from the server 2. The communication portion 303 further delivers, to the server 2, the intended use that is designated by the user and received from the use selection control portion 301. The communication portion 303 then sends, to the server 2, the original job 8 received from the job generating portion 302.

The user authentication portion 304 matches user information entered by the user for log-in operation with user registration information that is registered in advance. When the client terminal 3 makes a print request to the server 2, the user authentication portion 304 outputs, to the communication portion 303, the user information for identifying the logged-in user to be sent to the server 2.

The server 2 is configured of a storage 25 for storing the rule information 20 therein, a control portion 201, a job modifying portion 202, a communication portion 203, and so on. A non-illustrated CPU mounted as a computer on the server 2 executes a predetermined program, and thereby the control portion 201, the job modifying portion 202, and the communication portion 203 are implemented.

The control portion 201 receives a request for options to select a use of a printed matter from the client terminal 3 via the communication portion 203 which serves to perform communication with the client terminal 3. The control portion 201 then extracts, from the rule information 20, such options to select a use of a printed matter corresponding to a user of the client terminal 3, and notifies the client terminal 3 of the extracted options. Suppose that, for example, the user of the client terminal 3 is an employee of the sales department. In such a case, the two choices of “internal use” and “customer use” are provided as the options of “use” for the sales department as described above. The control portion 201, therefore, informs the client terminal 3 of the two choices. The control portion 201 also conveys the original job 8, received from the client terminal 3, to the job modifying portion 202, and informs the job modifying portion 202 of the intended use that is informed from the client terminal 3 and designated by the user (the selected option).

The job modifying portion 202 modifies the original job 8 received from the client terminal 3 to obtain a rule-based job 8R. The job modifying portion 202 gives the rule-based job 8R to the printer 4. To be specific, the job modifying portion 202 changes the print settings of the original job 8 in such a manner that the print settings conform with the print rules indicated in the rule information 20. If the original job 8 meets the print rules, the job modifying portion 202 gives the original job 8 to the printer 4 as the rule-based job 8R.

The printer 4 executes the rule-based job 8R received from the server 2. The printer 4 may be any printing device as long as the device has print functions corresponding to the print settings of the rule-based job 8R. The printing device may use the electrophotography technology, ink-jet method, or another technology.

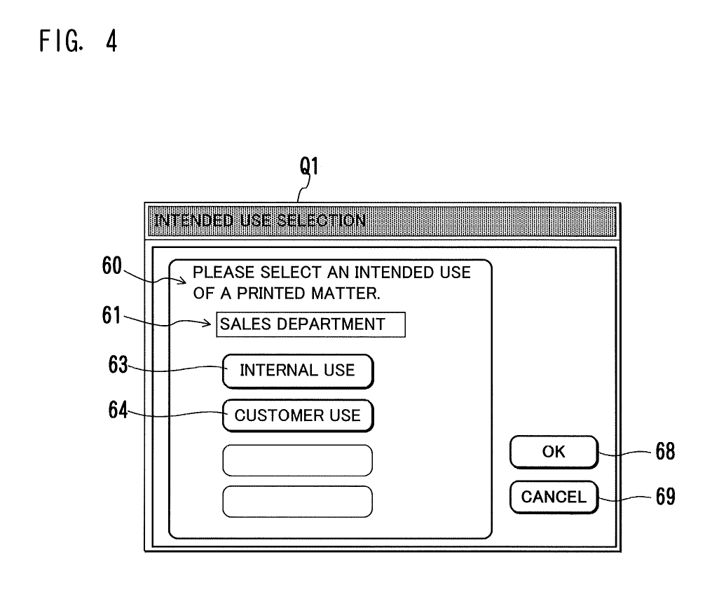

FIG. 4 shows a first example of an operating screen on which the user selects one from among intended uses displayed in the client terminal 3. In the illustrated example, an operating screen Q1 has a message 60 for prompting the user to select one of the intended uses, a field 61 in which a department corresponding to the client terminal 3 is displayed, and select buttons 63 and 64 corresponding to options to select an intended use of a printed matter.

The user of the client terminal 3 uses the operation receiving device 36 to select any one of the select buttons 63 and 64. If a mouse is provided as the operation receiving device 36, then the user performs click operation for the selection. If a touch-sensitive panel is provided as the operation receiving device 36, then the user performs touch operation for the selection.

The user selects any one of the select buttons 63 and 64 and presses an OK button 68. This means that the user designates an intended use corresponding to the selected button. The intended use designated on the operating screen Q1 is notified to the server 2 and is reflected in the rule-based job 8R as described above. When the user operates the cancel button 69, the print command based on which the operating screen Q1 has been displayed is cancelled, and generating an original job 8 is cancelled.

The display made on the operating screen Q1 can be realized by the use of existing software to create a screen display based on, for example, a template of screen data. Provided that the software and the template are stored in the client terminal 3, the server 2 only conveys information to be displayed such as options to select an intended use and the group names thereof (corresponding to the department names in this example). Stated differently, provided that the software and the template are stored in the client terminal 3, it is unnecessary to transfer, from the server 2 to the client terminal 3, screen data to represent the operating screen Q1. This means that the administrator 7 can easily change the settings of options to select an intended use. The administrator 7 is allowed to arbitrarily change the number of options and to give names to intended uses under the constraints of the maximum number of selection buttons, the number of characters of the intended uses, and so on in the template.

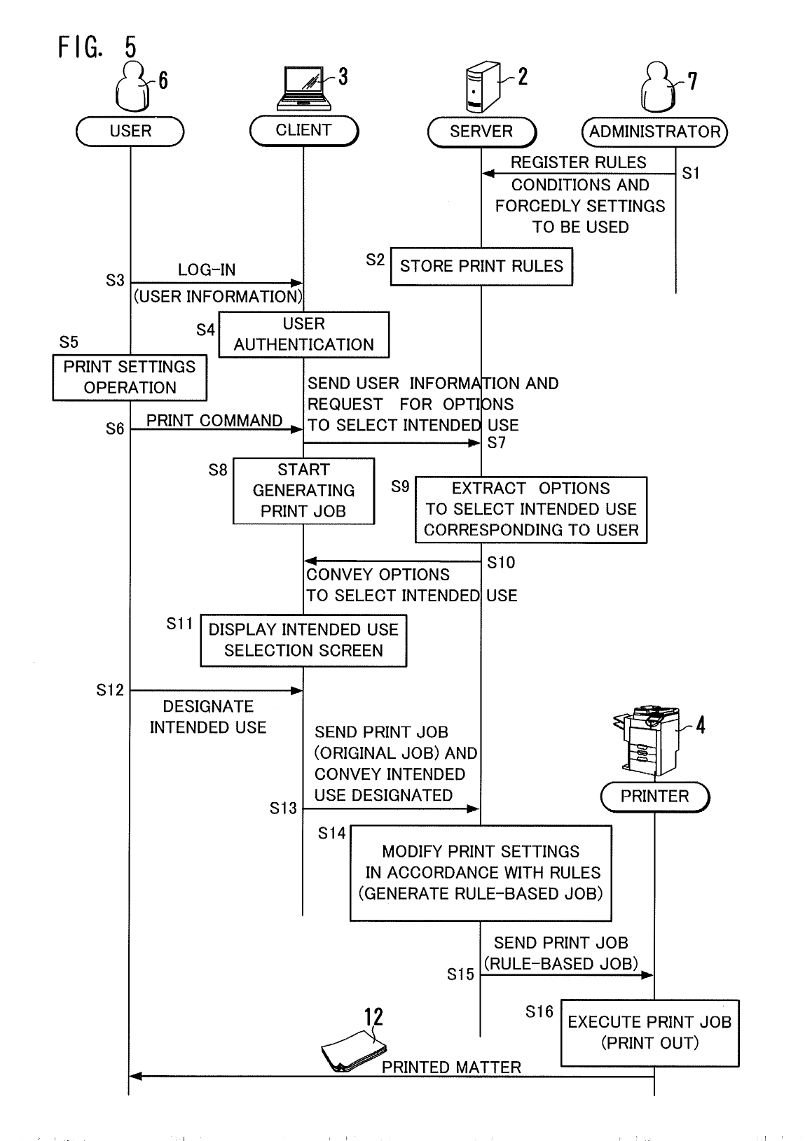

FIG. 5 shows a first example of a sequence of operation performed in the printing system 1.

The administrator 7 registers print rules (S1) before the user 6 of the client terminal 3 (called client 3 in the drawing) issues a print command. The administrator 7 registers in the server 2, as the rule information 20, the print rules in line with the corporate policy of, for example, “reducing the print cost to the lowest possible in a manner which does not interfere with work in each department”. The rule information 20 is stored in the storage of the server 2 (S2).

The user 6 who intends to use the client terminal 3 performs predetermined log-in operation (S3). User information for identifying the user 6 is entered to the client terminal 3, and the user 6 is successfully authenticated by the client terminal 3 (S4).

The user 6, who is the logged-in user to the client terminal 3, performs print settings operation if necessary (S5) when he/she gives a command to print a document. For example, the user 6 designates the paper size and the set of prints, selects print color, and switches between ON and OFF of printing of the header or watermark. When no operation is performed at this time, the current settings (default settings, for example) are applied.

When the user 6 gives the print command (S6), the client terminal 3 sends the user information representing the logged-in user to the server 2, and informs the server 2 that the user 6 has given the print command. Thereby, the server 2 is requested to send options to select an intended use (S7). In parallel with the request, the client terminal 3 starts generating a print job (original job) (S8). The server 2 thus requested identifies the user 6 based on the user information received from the client terminal 3, extracts the options to select an intended use of a printed matter corresponding to the user 6 from the rule information, and informs the client terminal 3 of the options (S9 and S10).

When receiving the extracted options from the server 2, the client terminal 3 displays an operating screen on which the user 6 selects one from among the options (S11). When the user 6 selects an intended use from among the options (S12), the client terminal 3 sends the original job to the server 2, and informs the server 2 of the intended use selected by the user 6 (S13).

The server 2 generates a print job (rule-based job) for instructing printing based on print settings in accordance with the intended use informed by the client terminal 3 (S14). The server 2 gives the rule-based job thus generated to the printer 4 (S15). The printer 4 then executes the rule-based job 8R (S16), so that a printed matter 12 is produced.

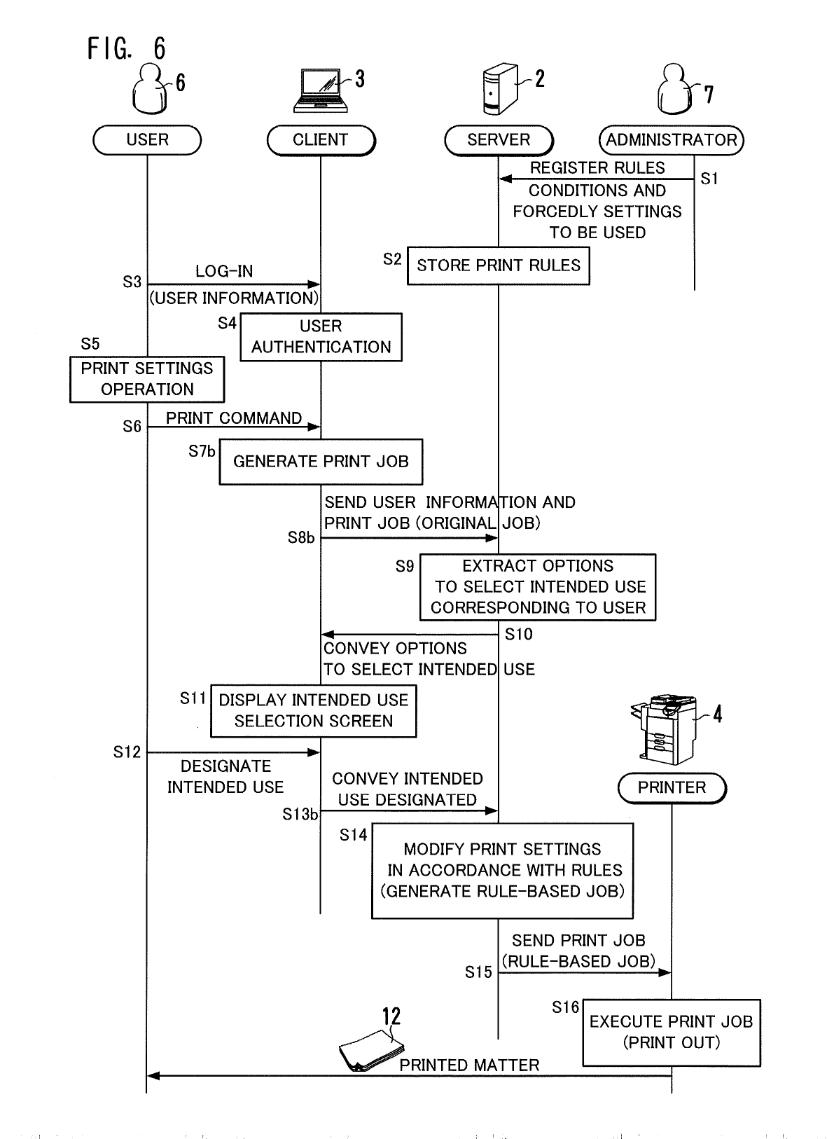

FIG. 6 shows a modified example of the sequence of operation performed in the printing system 1. As shown in the modified example, it is possible to change a time at which the client terminal 3 sends the original job. To be specific, in the example of FIG. 5, the client terminal 3 requests options to select an intended use from the server 2 before generating and sending the original job, and in response to the request, the server 2 informs the client terminal 3 of the options. In contrast, according to the modified example in FIG. 6, after receiving the original job, the server 2 requests options to select an intended use from the client terminal 3, and in response to the request, the client terminal 3 informs the server 2 of the intended use selected by the user 6. The detailed descriptions on this are provided below.

In response to a print command from the user 6 (S6), the client terminal 3 generates the original job (S7b) and sends, to the server 2, the original job and user information indicating the logged-in user (S8b). The server 2 identifies the user 6 based on the user information, extracts options to select an intended use corresponding to the user 6 from the rule information, and informs the client terminal 3 of the extracted options (S9 and S10). When receiving the information, the client terminal 3 displays an operating screen on which the user 6 selects an intended use (S11), and informs the server 2 of the intended use selected by the user 6 (S12 and S13b). The rest possessing is the same as that of FIG. 5. To be specific, the server 2 generates a rule-based job based on the intended use thus informed (S14), and causes the printer 4 to execute the generated rule-based job (S16).

### Second Embodiment

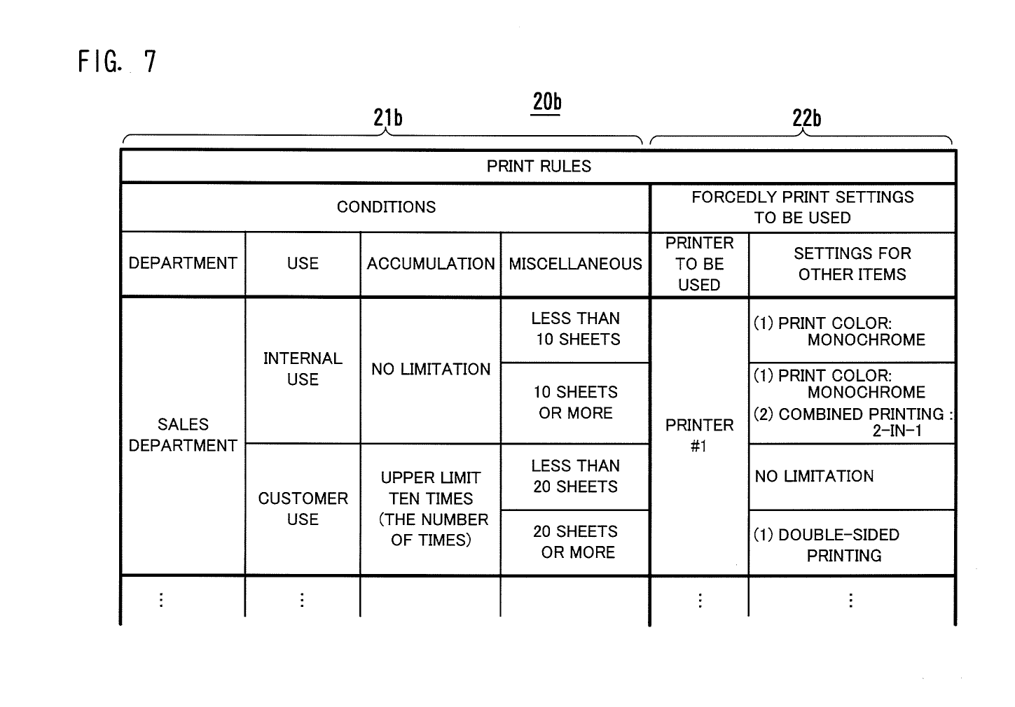

FIG. 7 shows rule information 20b according to the second embodiment. The rule information 20b has a section 21b showing “conditions” based on which applications of rules are classified into groups, and a section 22b showing “forcedly print settings to be used” corresponding to each of the groups classified. As shown in the rule information 20b, the conditions have four items of “department”, “use”, “accumulation”, and “miscellaneous”. In short, the conditions have the item of “accumulation” that is not exemplified in FIG. 2. The forcedly print settings to be used have two items of “printer to be used” and “other item settings” as with the example of FIG. 2.

The “accumulation” in this example is set in order to limit the number of execution times of a print job for each intended use of a printed matter. If no limitation is applied to the number of execution times of a print job, a user possibly tends to select same/similar intended use every time. In the illustrated example, attention is focused on the print rules for the sales department. If the use is “internal use”, the print color is limited to monochrome. If the use is “customer use”, the print color is not limited to monochrome. For this reason, although the actual use of a printed matter is “internal use”, a user possibly selects “customer use” as the intended use. The print settings are forcedly made in such a manner that printing cost for “internal use” becomes lower than that for “customer use”. Accordingly, incorrect selection of “customer use” loses the advantage of reducing the print cost in the rule-based printing. To cope with this, “accumulation” is provided for the purpose of making users aware of correct selection of an intended use of a printed matter. Information specified in the “accumulation” field is print limit information indicating the upper limit of printing which is set for each of the intended uses. In the illustrated example, no limitation of “accumulation” is put for “internal use”, and the upper limit of 10 times is specified in “accumulation” for “customer use”.

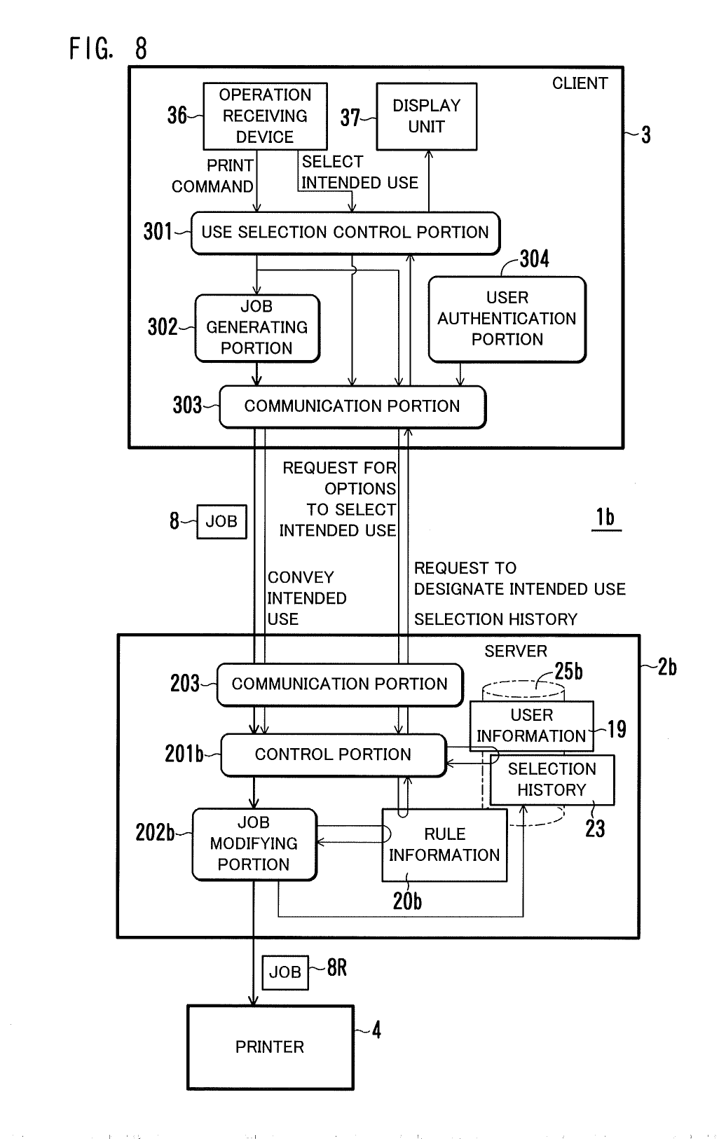

FIG. 8 shows the functional configuration of the printing system 1b according to the second embodiment. In FIG. 8, the constituent elements that are the same as those in FIG. 3 have been given the same reference signs, and detailed descriptions thereof have been omitted.

The printing system 1b includes a server 2b instead of the server 2 of the printing system 1 shown in FIG. 3. The server 2b is configured of a storage 25b for storing therein rule information 20b and selection history 23, a control portion 201b, a job modifying portion 202b, a communication portion 203, and so on. A non-illustrated CPU mounted as a computer in the server 2b executes a predetermined program, and thereby the control portion 201b, the job modifying portion 202b, and the communication portion 203 are implemented.

The control portion 201b receives a request for options to select a use of a printed matter from the client terminal 3 through the communication portion 203. The control portion 201b then extracts history information corresponding to a logged-in user of the client terminal 3 from the selection history 23, and also extracts options to select a use corresponding to the logged-in user of the client terminal 3 from the rule information 20b. The control portion 201b then informs the client terminal 3 of the extracted history information and the extracted options. The control portion 201b also conveys the original job 8, received from the client terminal 3, to the job modifying portion 202b, and informs the job modifying portion 202b of the use that is informed from the client terminal 3 and designated by the user (the selected option).

The job modifying portion 202b modifies the original job 8 received from the client terminal 3 to obtain a rule-based job 8R. The job modifying portion 202b gives the rule-based job 8R to the printer 4. In addition, as processing related to “accumulation” in the rule information 20b, the job modifying portion 202b conveys the rule-based job 8R to the printer 4, and updates the number of execution times of print job for each of the intended uses in the selection history 23. Stated differently, the job modifying portion 202b plays a role as a track record managing portion to count, for each of the intended uses, the number of executed jobs which increases every time when a rule-based job corresponding to the client terminal 3 is executed.

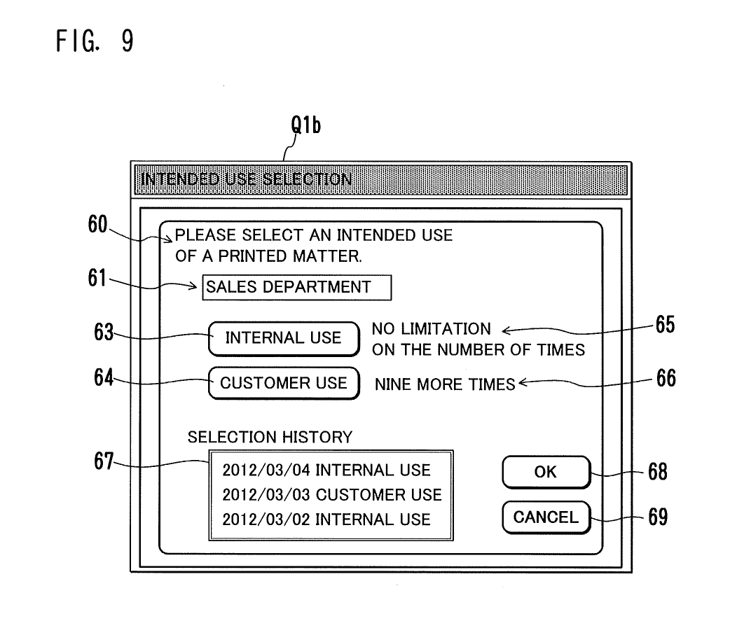

FIG. 9 shows an operating screen Q1b according to the second embodiment. The operating screen Q1b is displayed in order that a user of the client terminal 3 selects an intended use of a printed matter. In the illustrated example, the operating screen Q1b has a message 60 for prompting the user to select one of the intended uses, a field 61 in which a department corresponding to the client terminal 3 is displayed, select buttons 63 and 64 corresponding to options to select an intended use of a printed matter, and a history information display region 67.

The messages 65 and 66 displayed on the right of the select buttons 63 and 64 respectively are information indicating the current status of print limit on a use-by-use basis shown in “accumulation” of the conditions in the rule information 20b. According to the illustrated example, the message 65 corresponding to the select button 63 for “internal use” says that no limit is applied to the number of execution times of print job. In other words, the message 65 says that the intended use of “internal use” can be selected multiple times. The message 66 corresponding to the select button 64 for “customer use” shows how many more times the intended use of “customer use” can be selected. The history information display region 67 shows a selection operation history in which options selected as intended uses of printed matters, e.g., “internal use” and “customer use”, and the dates on which the user selected the options previously are associated with one another.

Display of the messages 65 and 66 enables the user to know how many more times printing can be performed for each of the intended uses. Further, display of the history information corresponding to the selection of an intended use enables the administrator 7 to inform the user of print status concerned for the user, and also to prompt the user to keep in mind the print rules.

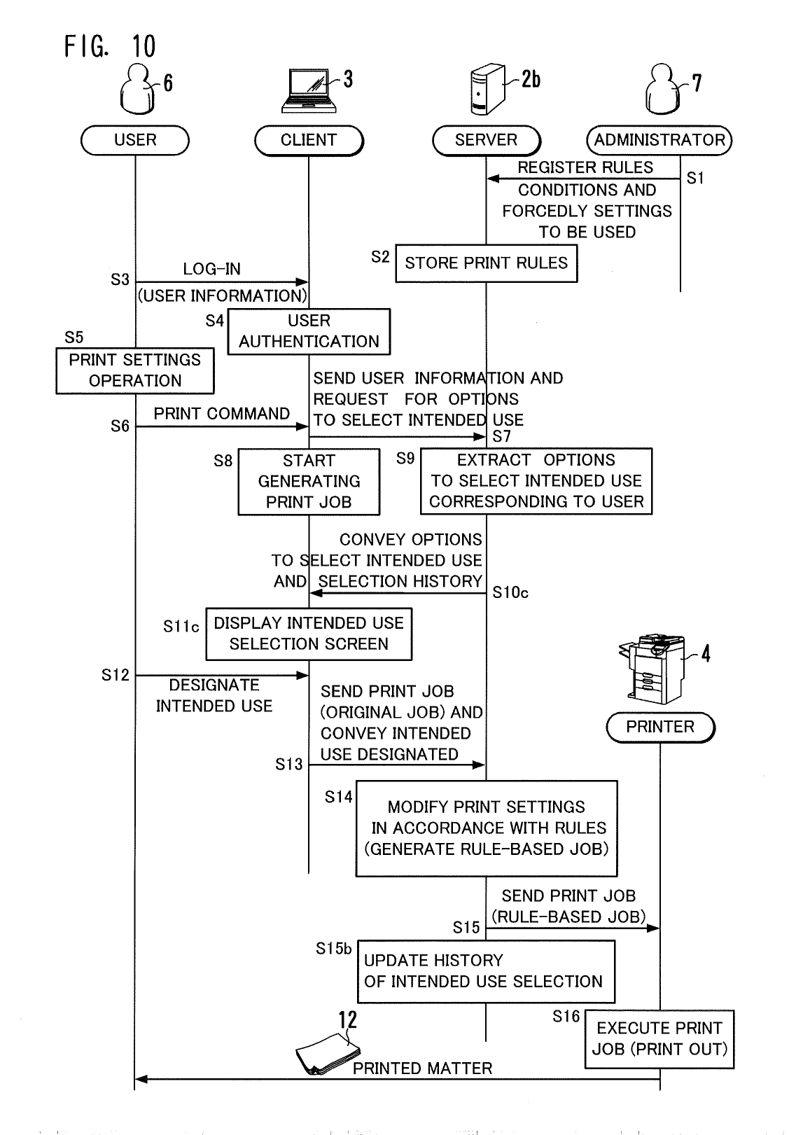

FIG. 10 shows a sequence of operation performed in the printing system 1b. The sequence of operation of FIG. 10 is basically the same as that of FIG. 5. Referring to FIG. 10, when the server 2b receives a request for options to select an intended use of a printed matter from the client terminal 3 (S7), the server 2b informs the client terminal 3 of the options corresponding to the client terminal 3, and the selection history information (S10c). The client terminal 3 then displays the operating screen Q1b shown in FIG. 9. After that, the server 2b gives a rule-based job based on the intended use selected by the user 6 to the printer 4 (S15), and updates the history of selection of intended use (S15b).

If the number of execution times of print job for “customer use” already reaches the upper limit number specified in “accumulation”, the select button 64 for “customer use” may be, for example, so grayed out that the user knows that the select button 64 for “customer use” is not selectable by the client terminal 3. Stated differently, the use selection control portion 301 may receive selection operation only for an intended use for which the number of execution times of rule-based job counted by the job modifying portion 202b is smaller than the upper limit number. This makes it easier for the user to know the print status related to himself/herself as compared to the case where a selection button for intended use that is not selectable due to the limitation on “accumulation” is not displayed.

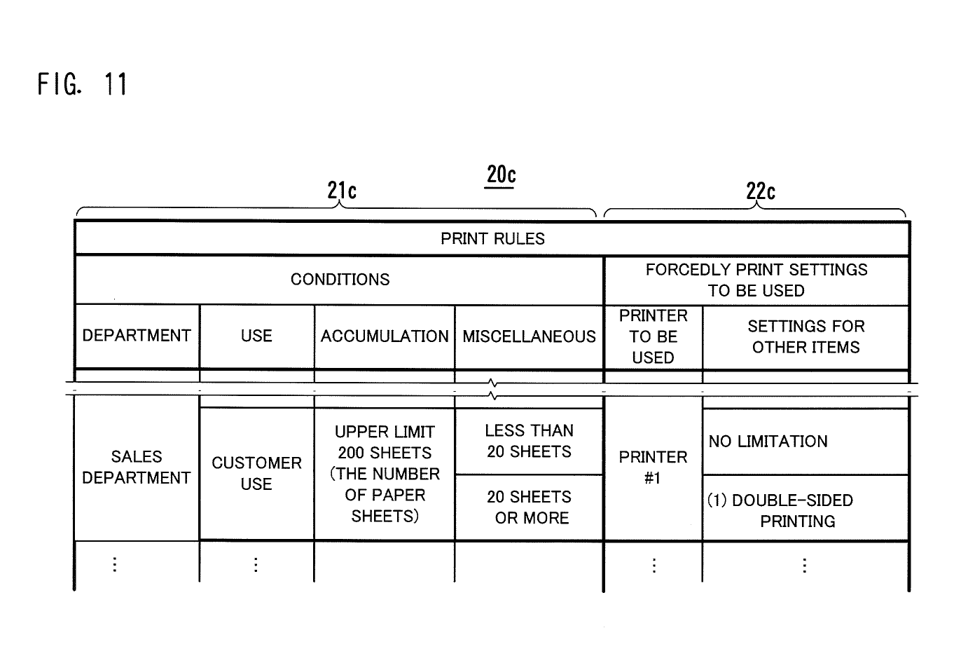

FIG. 11 shows a modified example of the rule information according to the second embodiment. The rule information 20c of FIG. 11 has a section 21c showing “conditions” based on which applications of rules are classified into groups, and a section 22c showing “forcedly print settings to be used” corresponding to each of the groups classified. As shown in the rule information 20c, “the number of sheets printed” rather than “the number of times” is limited, for each intended use, based on “accumulation” that is one item of the conditions. In the illustrated example, the upper limit of 200 is defined in “accumulation” for “customer use”.

According to the first and second embodiments, it is possible to provide a rule-based printing system that has flexibility in print settings depending on the intended use of a printed matter for each of the groups (departments) to which the client terminals 3, 3b, and 3c belong. The users 6, 6b, and 6c can obtain various printed matters of one printed target document by designating different intended uses thereof. In short, according to the first and second embodiments, the convenience of the printing system is enhanced for the standpoint of the users 6, 6b, and 6c. On the other hand, the administrator 7 modifies the rule information 20, 20b, and 20c in the servers 2 and 2b appropriately. Thereby, the number of options to select an intended use of a printed matter can be increased/decreased in accordance with the actual situation of the work.

One of possible methods to realize printing for each intended use of a printed matter is that a user incorporates a character string representing an intended use of a printed matter into the name of a print target document, and the server determines the intended use based on the character string. The method, however, poses a problem of taking time and energy to incorporate the character string, and another problem of taking time and energy for an administrator to inform each user of selectable uses in advance. Another possible method is that, for example, a user who is allowed only to give a monochrome print command requests an administrator to issue a special account for color printing. Unfortunately, this method requires both the user and the administrator to perform a burdensome task. The foregoing first and second embodiments do not involve such problems, and instead, realize printing for each intended use of a printed matter.

In the first and second embodiments, the print rules are not limited to the illustrated examples and may be defined arbitrarily. For example, the following arrangement is possible. As one of the intended uses, “outsourcing” is provided and “outsourcing” is associated with print settings of adding a watermark to a printed matter so as to prompt the user to treat the printed matter as a confidential document. Another arrangement is also possible in which “customer brochure” is set as one of the uses, and print settings of stapling a double-sided printed matter or a printed matter having a plurality of sheets of paper at two positions. Note that, when print settings such as adding watermark, double-sided printing, stapling, and punching are set, a printer having such functionality has to be set as a “printer to be used”. Another arrangement is also possible in which attributes of a print target document 9 in the original job 8 are set as one item of the conditions of the rule information, e.g., print settings are made different between text and picture.

When a predetermined amount of time has elapsed since the operating screen Q1 or Q1b was displayed with user having no operation to select an intended use, the client terminal 3 may automatically inform the server 2 of a predetermined intended use. Alternatively, when a predetermined amount of time has elapsed since the server 2 informed the client terminal 3 of options to select an intended use, it is possible to assume that a predetermined intended use has been conveyed.

In the sequence of operation of FIG. 6, in a case where the client terminal 3 corresponds to a department that is not applicable to any groups based on the use of a printed matter in the rule information 20, 20b, and 20c, e.g., the personnel department in the rule information 20 of FIG. 2, sending information of options to select an intended use from the server 2 to the client terminal 3 may be omitted. In such a case, displaying the operating screen Q1 to select an intended use in the client terminal 3 is omitted. Accordingly, when viewed from the user 6, the printer 4 executes a print job (rule-based job) in response to a print command from the user 6.

For the convenience of a user who always selects the same use, arrangement is possible in which the user performs option operation to select a predetermined use. For example, the indication of “always select this intended use” and a checkbox close thereto are provided on the operating screen Q1. In such a case, when the user checks the checkmark, the use selected this time will be automatically designated next time and onward.

The number of client terminals 3, 3b, and 3, and the number of printers 4 and 4b may be one or more. It is to be understood that the functional configurations of the client terminals 3, 3b, and 3c, the server 2, the hardware configurations thereof, the operation, and the like can be appropriately modified without departing from the spirit of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A printing system comprising:
a client terminal configured to generate a print job; and
a server configured to issue a print command in accordance with the print job to a printing device;
wherein
the server includes
a storage portion configured to store therein rule information, the rule information indicating print rules associated with intended uses of a printed matter, and
a control unit configured to inform the client terminal of the intended uses in response to a print command,
the client terminal includes
a receiving portion configured to receive a print command in accordance with print setting operation made by a user,
an intended use selection control unit configured to display an operating screen in which selection operation for selecting one from among the intended uses informed by the server in response to the print command is performed, and
a communication portion configured to inform the server of said one intended use selected in the operating screen, and
the server modifies print settings designated in an original job that is a print job sent from the client terminal to the server in accordance with the print rules associated with said one intended use selected, and gives, instead of the original job, a rule-based job to the printing device, the rule-based job being a print job in which post-modification print settings are designated.

2. The printing system according to claim 1, wherein
when operation for issuing a print command is performed, the communication portion of the client terminal accesses the server, and thereafter, the communication portion informs the server of said one intended use selected and sends the original job to the server, and
when the communication portion of the client terminal accesses the server, the control unit of the server informs the client terminal of the intended uses, and sends the rule-based job generated thereafter to the printing device.

3. The printing system according to claim 1, wherein
the communication portion of the client terminal sends the original job, and informs the server of said one intended use selected in the operating screen displayed thereafter, and
the control unit of the server informs the client terminal of the intended uses at a time when the original job is received.

4. The printing system according to claim 1, wherein the print rules indicated in the rule information define print settings in accordance with a combination of an intended use of a printed matter and information included in the original job.

5. The printing system according to claim 1, wherein the print rules are defined in the rule information on a group-by-group basis, and
the print rules to be applied in order to generate the rule-based job are print rules defined in the rule information for a group corresponding to the client terminal.

6. The printing system according to claim 1, comprising
print limit information indicating an upper limit which is set for each of the intended uses, and
a track record managing portion configured to count, for each of the intended uses, a track record number which increases every time when the rule-based job corresponding to the client terminal is executed; wherein
the intended use selection control unit receives the selection operation for selecting, from among the intended uses, only an intended use of which the track record number counted by the track record managing portion is smaller than the upper limit.

7. The printing system according to claim 6, wherein the track record number is an accumulation of a number of execution times of the rule-based job or an accumulation of a number of sheets printed.

8. The printing system according to claim 6, wherein the operating screen displays information showing a current status of print limit for each intended use shown in settings in the upper limit.

9. The printing system according to claim 1, wherein the operating screen displays a history of the selection operation.

10. A server for issuing a print command to a printing device in accordance with a print request from a client terminal, the server comprising:
a storage portion configured to store therein rule information, the rule information indicating print rules associated with intended uses of a printed matter; and
a control unit configured to inform the client terminal of the intended uses in response to a print command, and to obtain from the client terminal information indicating one intended use selected from among the intended uses; wherein
the server modifies print settings designated in an original job that is a print job sent from the client terminal in accordance with the print rules associated with said one intended use selected, and gives, instead of the original job, a rule-based job to the printing device, the rule-based job being a print job in which post-modification print settings are designated.

11. An information device for sending a print job to a server for printing, the information device comprising:
a receiving portion configured to receive a print command in accordance with print setting operation made by a user;
an intended use selection control unit configured to display, at a time when intended uses of a printed matter are informed by the server in response to the print command, an operating screen in which selection operation for selecting one from among the intended uses is performed; and
a communication portion configured to inform the server of said one intended use selected in the operating screen.

12. A non-transitory computer-readable storage medium storing thereon a computer program executed in an information device for sending a print job to a server for printing, the computer program causing a computer provided in the information device to perform processing comprising:
processing for displaying, at a time when intended uses of a printed matter are informed by the server, an operating screen in which selection operation for selecting one from among the intended uses is performed; and
processing for informing the server of said one intended use selected in the operating screen.

13. A non-transitory computer-readable storage medium storing thereon a computer program executed in a server for issuing a print command to a printing device in accordance with a print request from a client terminal, the computer program causing a computer provided in the server to perform processing comprising:
processing for informing the client terminal of intended uses in response to a print command;
processing for receiving, from the client terminal, information indicating one intended use selected from among the intended uses;
processing for modifying print settings designated in an original job that is a print job sent from the client terminal in accordance with a print rule associated with said one intended use selected in the rule information indicating the print rules associated with the intended uses of a printed matter; and
processing for giving, instead of the original job, a rule-based job to the printing device, the rule-based job being a print job in which post-modification print settings are designated.
